(19) United States
(12) Patent Application Publication
(10) Pub. No.: US 2015/0195366 A1
(43) Pub. Date: Jul. 9, 2015

(54) SWITCHING DEVICE, NON-TRANSITORY COMPUTER READABLE MEDIUM AND ZONING SETTING METHOD

(71) Applicant: FUJITSU LIMITED, Kawasaki-shi (JP)

(72) Inventors: Hiroshi Otsuka, Inagi (JP); Yuuki Uragou, Tokyo (JP)

(73) Assignee: FUJITSU LIMITED, Kawasaki-shi (JP)

(21) Appl. No.: 14/662,966

(22) Filed: Mar. 19, 2015

Related U.S. Application Data
(63) Continuation of application No. PCT/JP2012/074049, filed on Sep. 20, 2012.

(51) Int. Cl. H04L 29/08; G06F 17/30

(52) U.S. Cl. CPC H04L 67/18; G06F 17/30864

(57) ABSTRACT

A switching device 10 manages pieces of identification information (e.g., WWN: World Wide Name) on devices connected to ports and the port numbers of the ports, as pieces of information in a name service DB 32, and has a function of converting zoning setting in terms of a port into zoning setting in terms of a piece of identification information on a device based on the pieces of information, and a function of converting the zoning setting in terms of the piece of identification information on a device into the zoning setting in terms of the port based on the pieces of information.

### CROSS-REFERENCE TO RELATED APPLICATION

This application is a continuation application of International Application PCT/JP2012/074049 filed on Sep. 20, 2012 and designated the U.S., the entire contents of which are incorporated herein by reference.

### FIELD

The disclosures made herein relate to a switching device, a non-transitory computer readable medium and a zoning setting method.

### BACKGROUND

Typical fiber channel switches (FC switches) each have an access restricting function, called zoning, that separates devices (e.g., hosts and storages) to communicate with one another into zones (groups), and blocks access from devices not belonging to the same zone.

In addition, the zonings include WWN (World Wide Name) zoning by which zone separation is performed according to the WWNs of devices, and port zoning by which the zone separation is performed according to the port numbers of ports to which the devices are connected. Now, the WWN zoning allows the communication among just devices having specified WWNs, which can implement a network with high security. Setting the WWN zoning, however, needs to grasp (check) the WWNs of the devices.

In contrast, setting the port zoning needs to grasp just the port numbers of the ports to which the devices are connected. In the port zoning, unfortunately, if a device connected to a given port is replaced with another device, the other device is allowed to access the other devices subjected to the zoning (its security is low).

The following are related arts to the invention.
[Patent document 1] Japanese Patent Laid-Open Publication No. JP 2005-18159
[Patent document 2] Japanese Patent Laid-Open Publication No. JP H10-28130
[Patent document 3] Japanese Patent Laid-Open Publication No. JP 2002-312127

### SUMMARY

As described above, the port zoning and the WWN zoning each have both strong and weak points. For this reason, there is a case of intending the proper use between the port zoning and the WWN zoning, but existing FC switches are devices that allow their zoning class (the distinction between the port zoning and the WWN zoning) to be changed by just starting over port zoning setting/WWN zoning setting again.

According to an aspect of the disclosures made herein, a switching device includes: a plurality of ports; a connection management database that associates pieces of identification information on devices connected to the plurality of respective ports with pieces of identification information on the ports and manages the pieces of identification information; a zone specifying information storing unit in which a plurality of pieces of zone specifying information are stored, each of which is either a piece of class-1 zone specifying information to specify a plurality of devices to be subjected to zoning using pieces of identification information on the ports to which the plurality of devices are connected, or a piece of class-2 zone specifying information to specify a plurality of devices to be subjected to zoning using pieces of identification information on the plurality of devices; a zoning controlling unit that treats the plurality of devices connected to the plurality of ports as a plurality of zones based on the plurality of pieces of zone specifying information stored in the zone specifying information storing unit, and restricts access between the zones; and a zoning class changing unit that can perform a first zoning class converting process and a second zoning class converting process, the first zoning class converting process obtaining, from the connection management database, pieces of identification information on devices connected to ports whose pieces of identification information are contained in a given piece of class-1 zone specifying information and changing the piece of class-1 zone specifying information in the zone specifying information storing unit to a piece of class-2 zone specifying information containing the obtained pieces of identification information on the devices, and the second zoning class converting process obtaining, from the connection management database, pieces of identification information on ports to which devices are connected whose pieces of identification information are contained in a given piece of class-2 zone specifying information and changing the class-2 zone specifying information in the zone specifying information storing unit to a piece of class-1 zone specifying information containing the obtained pieces of identification information on the ports.

According to an aspect of the disclosures made herein, a non-transitory computer readable medium recorded with a control program that causes a processor in a switching device to execute processing includes:

the switching device includes a plurality of ports; a connection management database that associates pieces of identification information on devices connected to the plurality of respective ports with pieces of identification information on the ports and manages the pieces of identification information; a zone specifying information storing unit in which a plurality of pieces of zone specifying information are stored, each of which is either a piece of class-1 zone specifying information to specify a plurality of devices to be subjected to zoning using pieces of identification information on the ports to which the plurality of devices are connected, or a piece of class-2 zone specifying information to specify a plurality of devices to be subjected to zoning using pieces of identification information on the plurality of devices; a zoning controlling unit that treats the plurality of devices connected to the plurality of ports as a plurality of zones based on the plurality of pieces of zone specifying information stored in the zone specifying information storing unit, and restricts access between the zones; and the processor;

performing a first zoning class converting process and a second zoning class converting process, the first zoning class converting process obtaining, from the connection management database, pieces of identification information on devices connected to ports whose pieces of identification information are contained in a given piece of class-1 zone specifying information and changing the piece of class-1 zone specifying information in the zone specifying information storing unit to a piece of class-2 zone specifying information containing the obtained pieces of identification information on the devices, and the second zoning class converting process obtaining, from the connection management database, pieces of identification information on ports to which devices are connected whose pieces of identification information are contained in a given piece of class-2 zone specifying information and changing the class-2 zone specifying information in the zone specifying information storing unit to a piece of class-1 zone specifying information containing the obtained pieces of identification information on the ports.

According to an aspect of the disclosures made herein, a zoning setting method by which a processor in a switching device executes processing includes:

the switching device includes a plurality of ports; a connection management database that associates pieces of identification information on devices connected to the plurality of respective ports with pieces of identification information on the ports and manages the pieces of identification information; a zone specifying information storing unit in which a plurality of pieces of zone specifying information are stored, each of which is either a piece of class-1 zone specifying information to specify a plurality of devices to be subjected to zoning using pieces of identification information on the ports to which the plurality of devices are connected, or a piece of class-2 zone specifying information to specify a plurality of devices to be subjected to zoning using pieces of identification information on the plurality of devices; a zoning controlling unit that treats the plurality of devices connected to the plurality of ports as a plurality of zones based on the plurality of pieces of zone specifying information stored in the zone specifying information storing unit, and restricts access between the zones; and the processor;

obtaining, for each piece of class-1 zone specifying information in the zone specifying information storing unit, from the connection management database, pieces of identification information on devices connected to ports whose pieces of identification information are contained in the piece of class-1 zone specifying information to create a piece of class-2 zone specifying information containing the obtained pieces of identification information on the devices, and changing each piece of class-1 zone specifying information in the zone specifying information storing unit to the created piece of class-2 zone specifying information.

Objects and advantages of the disclosures will be realized and attained by means of the elements and combinations particularly pointed out in the claims.

### BRIEF DESCRIPTION OF THE DRAWINGS

FIG. 1 is an explanatory diagram of the configuration and the usage pattern of a switching device in an embodiment;

FIG. 2 is a flow chart of a first zoning class converting process performed by a CPU of the switching device in the embodiment;

FIG. 3 is a flow chart of a second zoning class converting process performed by the CPU of the switching device in the embodiment;

FIG. 4 is a flow chart of a third zoning class converting process performed by the CPU of the switching device in the embodiment;

FIG. 5 is a flow chart of a changed device checking process performed by the CPU of the switching device in the embodiment;

FIG. 6 is an explanatory diagram of a removed device information registering process; and

FIG. 7 is a flow chart of a removed device checking process performed by the CPU of the switching device in the embodiment.

### DESCRIPTION OF EMBODIMENTS

An embodiment of the disclosures made herein will be described below referring to the drawings in detail. The drawings illustrate a preferred embodiment. It should be understood, however, that the embodiment can be implemented by many different embodiments, and is not limited to the embodiment described herein.

An embodiment of the disclosed technique will be described in detail below with reference to the drawings.

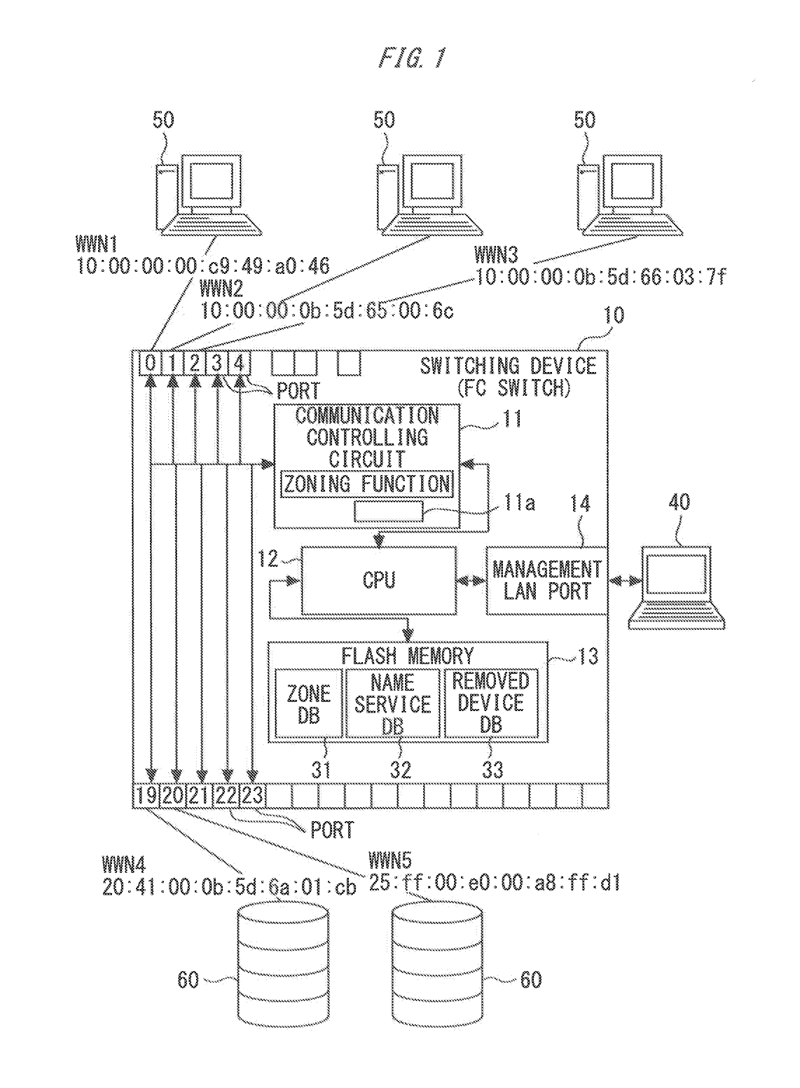

A switching device 10 in the embodiment will be first schematically described with reference to FIG. 1.

The switching device 10 in the embodiment is a device that is classified into a “fiber channel (FC) switch having a name-server function.” As illustrated in FIG. 1, the switching device 10 includes a plurality of ports, a communication controlling circuit 11, a CPU (Central Processing Unit) 12, a flash memory 13, and a management LAN (Local Area Network) port 14. In addition, the switching device 10 also includes a RAM (Random Access Memory; not illustrated).

The ports included in the switching device 10 are interfaces (so-called “F-ports”) for communication with devices, such as a host (server) 50, a storage (e.g., a tape storage or disk storage) 60, and the like. Each port is connected to a communication adapter (so-called “N-port”) of each device by an FC cable. Note that, in FIG. 1, numerical values illustrated inside the ports (e.g., “0” and “19”) are port numbers (identification information) of the ports.

The communication controlling circuit 11 is an ASIC (Application Specific Integrated Circuit) that transfers communication data received at each port to a port corresponding to address information on the communication data (or the CPU 12 in some cases).

This communication controlling circuit 11 operates, when some pieces of zone specifying information are set to a built-in memory 11a thereof, while transferring just communication data between devices belonging to the same zone (while performing zoning). Here, the zone specifying information is information to specify a plurality of devices to be members in a given zone using the WWNs (World Wide Names) of (the communication adapters of) the device, or using the port numbers of the ports in the switching device 10 to which the devices are connected. Hereafter, the zone specifying information of a type which specifies devices (the plurality of devices to be the members in the given zone) to be subjected to zoning using the port numbers of the ports to which the devices are connected will be expressed as class-1 zone specifying information. In addition, the zone specifying information of a type which specifies the devices to be subjected to the zoning using their WWNs will be expressed as class-2 zone specifying information.

The management LAN port 14 is a port to which an operating terminal 40 is connected in constructing or maintaining a SAN (Storage Area Network) having the switching device 10 as a component. Note that, as the operating terminal 40, a personal computer provided with a Web browser installed therein is commonly used.

The CPU 12 is a unit that integrally controls the units of the switching device 10 based on information from the operating terminal 40 and the communication controlling circuit 11.

The flash memory 13 is a rewritable nonvolatile memory where a zone database (DB) 31, a name service DB 32, and a removed device DB 33 are stored. In this flash memory 13, a control program to be read and executed on the RAM by the CPU 12 is also stored.

Each of the zone DB 31, the name service DB 32, and the removed device DB 33 is a database referred to/updated by the CPU 12 that executes the control program (hereafter, simply referred to as the CPU 12).

The name service DB 32 is a database to hold (store) the WWN, the manufacturer/vendor name, the model name, and the like of the device (the connection adapters of the device) connected to each port in the switching device 10, associating them with the port number of each port. Note that the CPU 12 stores information that each device transmits (registers) when being connected to the switching device 10, in the name service DB 32, associating it with the port number of the port at which the information is received. In addition, when the connection with a certain device is broken, the CPU 12 deletes information on the device (WWN, manufacturer/vendor name, model name and the like; hereafter, expressed as device information) from the name service DB 32.

The removed device DB 33 is a database to hold a piece of device information on a device (the connection adapter of the device) that is detached from each port in the switching device 10, associating it with the port number of the port. The update timings or the like of this removed device DB 33 by the CPU 12 will be described hereafter.

The zone DB 31 is a database where the same constellation of zone specifying information (class-1 zone specifying information or class-2 zone specifying information) as that set to (the memory 11a of) the communication controlling circuit 11 is stored.

The CPU 12 causes, when receiving a given HTTP (hypertext transfer protocol) request from the operating terminal 40, the display of the operating terminal 40 to display a zone specifying Web page. This zone specifying Web page allows a user (e.g., an administrator) of the switching device 10 to specify a plurality of devices to be members in a zone, using the port numbers of the ports to which the devices are connected, or the WWNs of the devices. When the plurality of port numbers are used to specify the plurality of devices to be the members in the zone, the CPU 12 creates a piece of class-1 zone specifying information containing the plurality of port numbers. In addition, when the plurality of WWNs are used to specify the plurality of devices to be the members in the zone, the CPU 12 creates apiece of class-2 zone specifying information containing the plurality of WWNs. The CPU 12 then stores the created piece of zone specifying information in the zone DB 31 and sets it to the communication controlling circuit 11, after deleting existing piece of zone specifying information from the zone DB 31 and the communication controlling circuit 11, if needed.

Note that the CPU 12 accepts the setting of zone specifying information via a telnet (telecommunication network) command. The user can therefore set the zone specifying information using the operating terminal 40 with no Web browser installed/without using the Web browser.

In addition, the CPU 12 determines in its boot-up (when the switching device 10 is turned on) whether any piece of zone specifying information is stored in the zone DB 31. If some pieces of zone specifying information are stored in the zone DB 31, the CPU 12 performs a process of setting the pieces of zone specifying information in the zone DB 31 to the communication controlling circuit 11.

On the above premises, the function of the switching device 10 (the CPU 12) will be described below more specifically.

The CPU 12 of the switching device 10 has a function of performing first to third zoning class converting processes, a changed device checking process, a removed device checking process, and the like.

The detail of the processes will be described in conjunction with the circumstances where the processes are utilized.

[In Constructing SAN]

To construct a new SAN using the switching device 10, devices to be components of the SAN (e.g., a host 50 and a storage 60) are connected with FC cables to specified ports (the ports determined by a user) in the switching device 10. In addition, the operating terminal 40 is connected to the management LAN port 14 in the switching device 10.

The user then operates the operating terminal 40 to conduct, for each zone to be created, an operation of specifying a plurality of devices to be members in the zone using the port numbers of the ports to which the devices are connected (hereafter, expressed as a port zoning setting operation). Note that this port zoning setting operation is performed using the Web browser of the operating terminal 40 or inputting the telnet command for zone specifying information setting from the keyboard of the operating terminal 40, as already described.

It is clear from the above-described functions of the CPU 12 and the communication controlling circuit 11 that performing the port zoning setting operation causes some pieces of class-1 zone specifying information to be registered in the zone DB 31. In addition, the same pieces of class-1 zone specifying information as those registered in the zone DB 31 are set to (the memory 11a in) the communication controlling circuit 11. Accordingly, the switching device 10 (the communication controlling circuit 11) is brought into a state of performing the port zoning with contents specified/set by the user.

When finishing the port zoning setting operation, the user checks whether each host 50 can access the storage 60 in the same zone to confirm that the port zoning setting (and the connections of devices to the switching device 10) has been correctly conducted. Note that if the port zoning setting has not been correctly performed, the user redoes the port zoning setting operation (and/or an operation of connecting some devices to the switching device 10).

When confirming that the port zoning setting has been correctly conducted, the user conducts, on the operating terminal 40, an operation of causing the CPU 12 to start the first zoning class converting process (the operation of using the Web browser, or the operation of inputting a given telnet command from the keyboard).

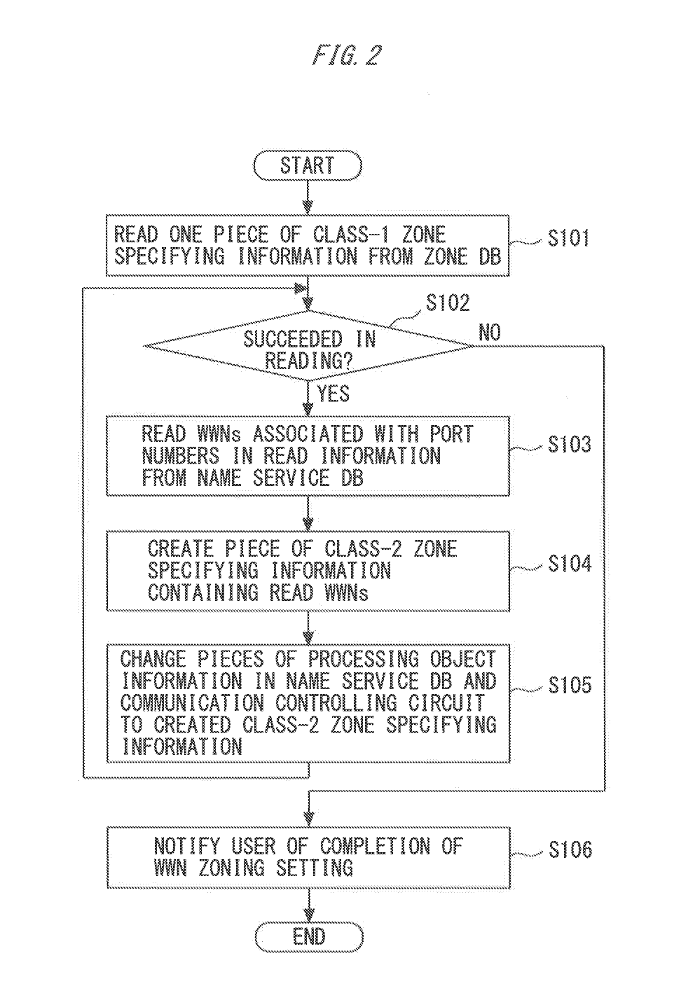

When the operation is conducted, the CPU 12 performs the first zoning class converting process the procedure of which is illustrated in FIG. 2.

That is, the CPU 12 that starts the first zoning class converting process first reads a piece of class-1 zone specifying information from the zone DB 31 (step S101). Note that if the piece of class-1 zone specifying information is absent in the zone DB 31, the CPU 12 retains the absence and finishes the process of this step S101.

If the piece of class-1 zone specifying information can be read from the zone DB 31 (step S102; YES), the CPU 12 reads WWNs associated with port numbers contained in the piece of class-1 zone specifying information from the name service DB 32 (step S103).

Next, the CPU 12 creates a piece of class-2 zone specifying information containing the plurality of WWNs read from the name service DB 32 (step S104).

Subsequently, the CPU 12 changes pieces of processing object information in the name service DB 32 and the communication controlling circuit 11 (the memory 11a) to the created piece of class-2 zone specifying information (step S105). Note that the piece of processing object information in the name service DB 32 is the piece of class-1 zone specifying information in the name service DB 32 that is read this time. In addition, the piece of processing object information in the communication controlling circuit 11 is the piece of class-1 zone specifying information set to the communication controlling circuit 11 (the memory 11a), which has the same content as that of the piece of class-1 zone specifying information read from name service DB 32 this time.

The CPU 12 that has finished the process of step S105 then restarts the process of step S101 and the following steps.

The CPU 12 repeats the above-described processes until failing to read a piece of class-1 zone specifying information from the zone DB 31 (step S102; NO). That is, the CPU 12 repeats the above-described processes until all the pieces of class-1 zone specifying information in the zone DB 31 and the communication controlling circuit 11 are converted into the pieces of class-2 zone specifying information.

When the conversion of all the pieces of class-1 zone specifying information into the pieces of class-2 zone specifying information is completed (step S102; NO), the CPU 12 notifies the user of the completion of setting the WWN zoning (step S106). More specifically, the CPU 12 performs in this step S106 a process of transmitting information compliant with a communication protocol with the operating terminal 40, that is, HTML data or text data (a telnet response), to the operating terminal 40.

When finishing the process of step S106, the CPU 12 finishes the first zoning class converting process (the process of FIG. 2). In addition, when the first zoning class converting process is finished, the switching device 10 (the communication controlling circuit 11) is brought into a state of performing the WWN zoning on all the zones.

[In Adding Zone]

To add some zones to the SAN that has been constructed as described above, devices to be members in each of the zones are connected to specific ports (the ports determined by the user) in the switching device 10 using FC cables. In addition, the operating terminal 40 is connected to the management LAN port 14 in the switching device 10.

Subsequently, the user operates the operating terminal 40 to conduct, for each zone to be added, a port zoning setting operation of specifying the device to be the members in each zone using the port numbers of the ports to which the devices are connected.

When finishing the port zoning setting operation, the user checks whether hosts 50 in each of the added zones can access the storage 60 in the same zone to confirm that the port zoning setting has been correctly conducted.

When confirming that the port zoning setting has been correctly conducted, the user operates the operating terminal 40 to cause the CPU 12 to perform the first zoning class converting process (FIG. 2).

As already described, the first zoning class converting process is a process in which no change is added to the pieces of class-2 zone specifying information in the zone DB 31 and the communication controlling circuit 11. Accordingly, causing the CPU 12 to perform the first zoning class converting process after the operation above brings the switching device 10 into the state of performing the WWN zoning on all the zones.

[In Changing Device (First Case)]

To change a given device in the SAN that has been constructed using the switching device 10, the user operates the operating terminal 40 to cause the CPU 12 to perform a second zoning class converting process specifying a zone to which the device belongs (hereafter, expressed as a processing object zone).

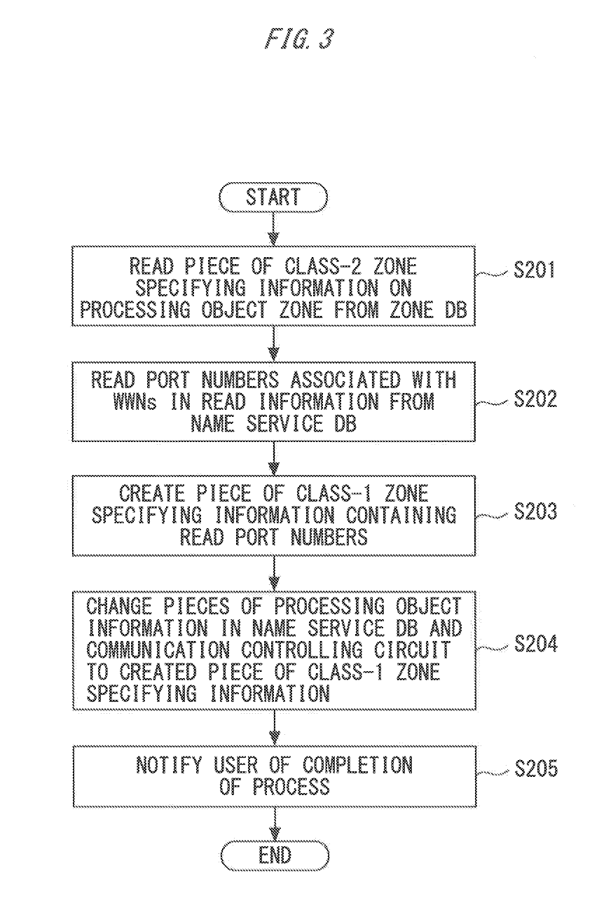

The second zoning class converting process to be performed by the CPU 12 is a process the procedure of which is illustrated in FIG. 3.

That is, the CPU 12 that starts this second zoning class converting process first reads a piece of class-2 zone specifying information on the processing object zone from the zone DB 31 (step S201). Next, the CPU 12 reads port numbers associated with WWNs contained in the read piece of class-2 zone specifying information from the name service DB 32 (step S202).

Subsequently, the CPU 12 creates a piece of class-1 zone specifying information containing the plurality of port numbers read from the name service DB 32 (step S203). The CPU 12 then changes the piece of processing object information in the name service DB 32 (the piece of class-2 zone specifying information in the name service DB 32 that is read this time) to the created piece of class-1 zone specifying information (step S204). In addition, the CPU 12 changes the piece of processing object information in the communication controlling circuit 11 (the piece of class-2 zone specifying information in the communication controlling circuit 11 corresponding to the piece of class-2 zone specifying information that is read from the name service DB 32 this time) to the created piece of class-1 zone specifying information (step S204).

In short, the CPU 12 performs a process of changing the zoning class relating to the processing object zone from the WWN zoning to the port zoning in steps S201 to 204.

Subsequently, the CPU 12 notifies the user of the completion of the process (step S205). More specifically, the CPU 12 performs a process of transmitting information in a form compliant with the communication protocol with the operating terminal 40, that is, HTML data or text data (a telnet response), to the operating terminal 40. The CPU 12 then finishes this second zoning class converting process (the process of FIG. 3).

The user who has been notified of the completion of the process changes the device that needs to be changed due to a failure or the like (hereafter, expressed as a used device) to a new device. This changing operation is conducted in such a manner that the new device is connected to a port to which the used device has been connected.

The user who has finished changing the used device to the new device checks that the new device (an initiator/target) can access devices in the same zone. Note that if the zoning class relating to the processing object zone remains the WWN zoning, this checking operation is to be inoperative, but the zoning class relating to the processing object zone has been changed to the port zoning. The user can therefore check whether the new device can access the devices in the same zone, and conducts an operation of, for example, changing the port to connect the new device to a correct port, if needed.

The user who has confirmed no problem with the connection operates the operating terminal 40 to cause the CPU 12 to perform the first zoning class converting process (FIG. 2). That is, the user returns a zoning method relating to the zone where the device has been changed (processing object zone) to the WWN zoning the security of which is higher than that of the port zoning.

[In Changing Entire Connection of SAN]

To substantially change the entire connection of the SAN (e.g., the disposition of the FC cables from the devices to the switching device 10), the user operates the operating terminal 40 to cause the CPU 12 to perform the third zoning class converting process.

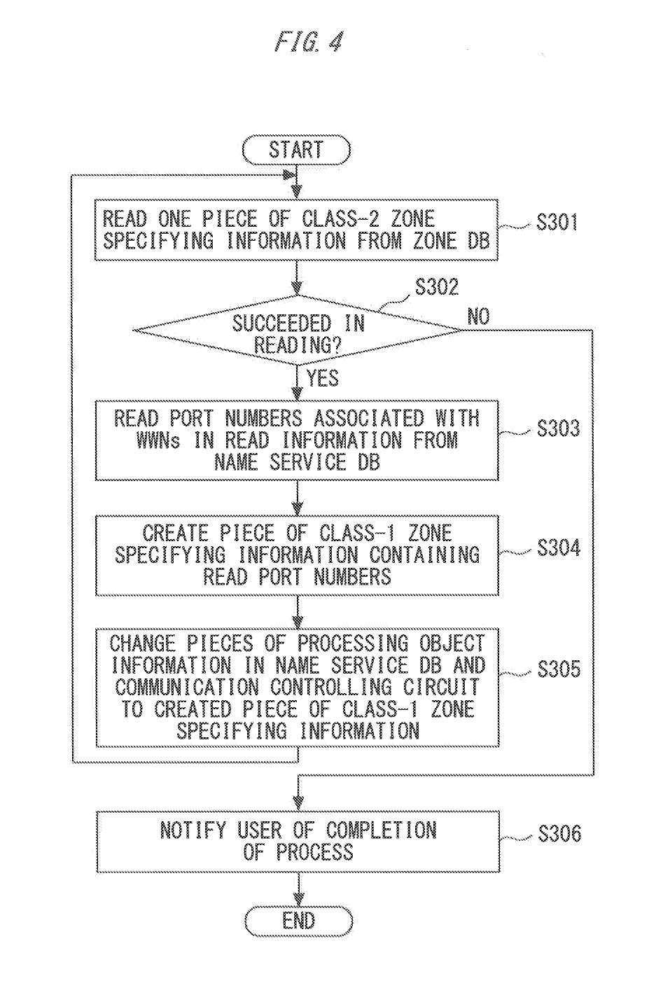

The third zoning class converting process to be performed by the CPU 12 is a process the procedure of which is illustrated in FIG. 4.

That is, the CPU 12 that starts this third zoning class converting process first reads a piece of class-2 zone specifying information from the zone DB 31 (step S301). Note that if the piece of class-2 zone specifying information is absent in the zone DB 31, the CPU 12 retains the absence and finishes the process of this step S301.

If the piece of class-2 zone specifying information can be read from the zone DB 31 (step S302; YES), the CPU 12 reads port numbers associated with the WWNs contained in the piece of class-2 zone specifying information from the name service DB 32 (step S303).

Next, the CPU 12 creates a piece of class-1 zone specifying information containing the port numbers read from the name service DB 32 (step S304). Subsequently, the CPU 12 changes the pieces of processing object information in the name service DB 32 and the communication controlling circuit 11 (the piece of class-2 zone specifying information in the name service DB 32 that is read this time and the piece of class-2 zone specifying information in the communication controlling circuit 11 corresponding thereto) to the created piece of class-1 zone specifying information (step S305).

The CPU 12 that has finished the process of step S305 then restarts the process of step S301 and the following steps.

The CPU 12 repeats the above-described processes until failing to read a piece of class-2 zone specifying information from the zone DB 31 (step S302; NO), that is, until the zoning classes relating to all the zones are changed to the port zoning.

If failing to read a piece of class-2 zone specifying information from the zone DB 31 (step S302; NO), the CPU 12 notifies the user of the completion of the process (step S306), and finishes this third zoning class converting process.

The user who has been notified of the completion of the third zoning class converting process changes the connection state between the devices and the switching device 10 to a desired one. In addition, the user operates the operating terminal 40 to conduct the port zoning setting operation of specifying the plurality of devices to be members in each zone using the port numbers of the port to which the devices are connected.

The user who has finished the port zoning setting operation tries access or the like from the hosts 50 to the storage 60 in the same zone to confirm that the zoning setting (and the connection of the devices to the switching device 10) has been correctly conducted.

The user who has confirmed that the zoning setting has been correctly confirmed causes the CPU 12 to perform the first zoning class converting process (FIG. 2) to change the zoning class relating to each zone to the WWN zoning the security of which is higher than that of the port zoning.

[In Changing Device (Second Case)]

A changed device checking process is a process that is utilized in changing a device connected to the switching device 10.

To change a device utilizing the changed device checking process, the user conducts, on the operating terminal 40, a start instructing operation of the changed device checking process including an operation of specifying a port to which the device to be changed is connected. In short, the user conducts, on the operating terminal 40, the start instructing operation of selecting from various kinds of items on the Web page, and the start instructing operation of inputting a command with an operand.

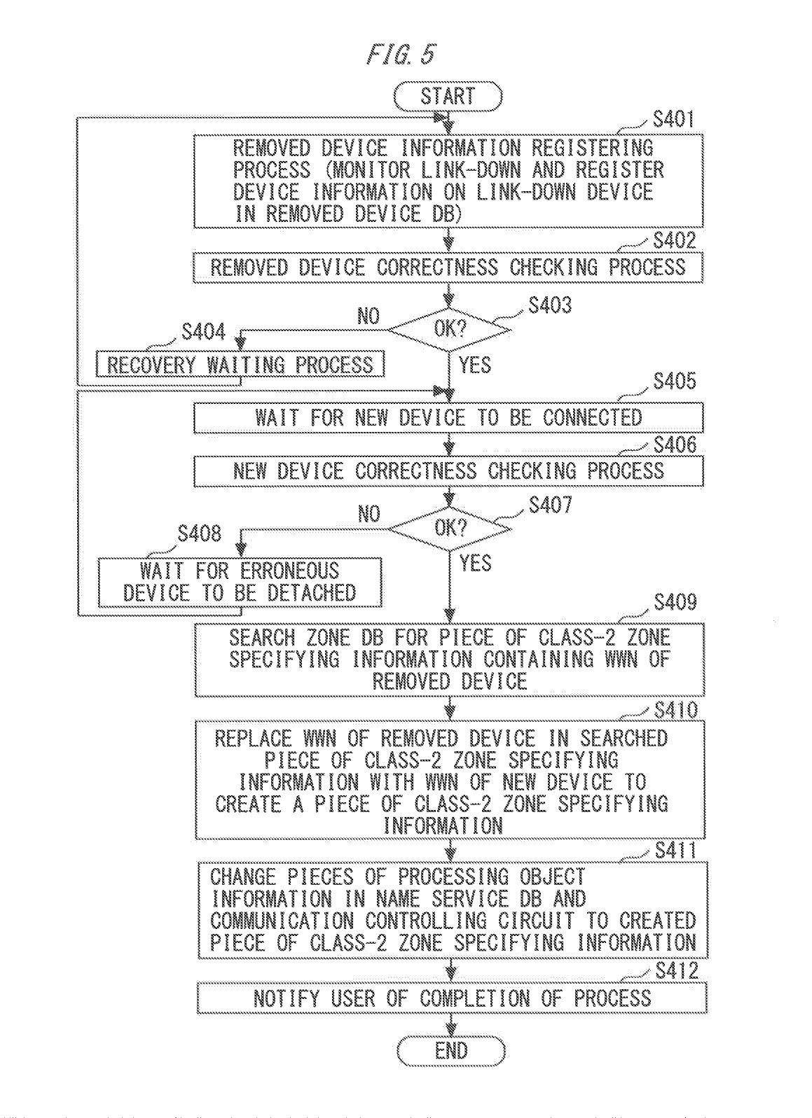

When the start instructing operation above is conducted, the CPU 12 starts the changed device checking process, the procedure of which is illustrated in FIG. 5, with a removed device information registering process (step S401).

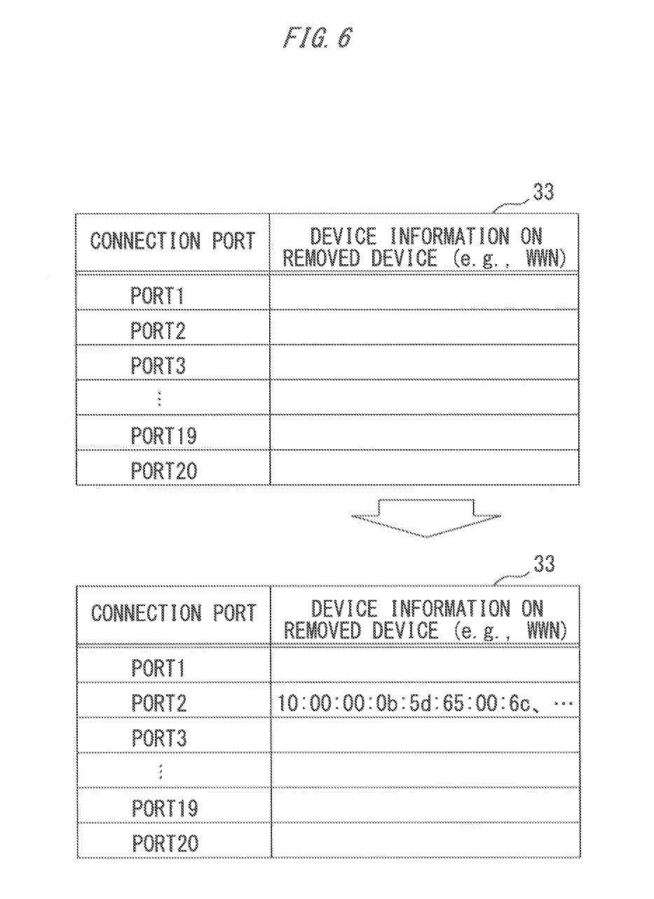

This removed device information registering process is a process of monitoring a link-down of a device, and registering device information on a link-down device (hereafter, expressed as a removed device) in the removed device DB 33. More specifically, for example, if a device connected to a port 2 (a port having a port number 2) is subjected to link-down, a process of changing the content of the removed device DB 33 as illustrated in FIG. 6 is performed in step S401.

The CPU 12 that has finished the process of step S401 performs a removed device correctness checking process (step S402). This removed device correctness checking process is a process of displaying device information and the like on the removed device on the display of the operating terminal 40 to ask the user whether the removed device is correct one.

Then, when obtaining a response from the user indicating that the removed device is incorrect one (step S403; NO), the CPU 12 performs a recovery waiting process of waiting for the removed device to be reconnected to the original port (step S404). This recovery waiting process is a process that terminates when the removed device is reconnected to the original port (a process that does not terminate when the removed device is reconnected to the other port). In addition, the recovery waiting process is also a process that terminates after the device information registered in the removed device DB 33 is deleted in the process of step S401.

If obtaining a response from the user indicating that the removed device is correct one (step S403; YES), the CPU 12 waits for the new device to be connected (step S405). More specifically, the CPU 12 waits device information on the new device (WWN and the like) to be registered in the name service DB 32 through the other process performed by itself.

Then, when the new device is connected, the CPU 12 performs a new device correctness checking process (step S406). This new device correctness checking process is a process of displaying the difference between the pieces of device information on the removed device and the new device on the display of the operating terminal 40 to ask the user whether the new device (or the combination of the removed device and the new device) is correct one.

When obtaining a response from the user indicating that the new device is incorrect one (step S407; NO), the CPU 12 waits the new device to be detached (step S408), and restarts the process of step S405 and the following processes.

In contrast, when obtaining a response from the user indicating that the new device is correct one (step S407; YES), the CPU 12 searches the zone DB 31 for a piece of class-2 zone specifying information containing the WWN of the removed device (step S409).

Next, the CPU 12 creates a piece of class-2 zone specifying information in which the WWN of the removed device contained in the searched class-2 zone specifying information is replaced with the WWN of the new device (step S410). Subsequently, the CPU 12 changes the pieces of processing object information in the name service DB 32 and the communication controlling circuit 11 (the piece of class-2 zone specifying information in the name service DB 32 that is read this time, and the same piece of class-2 zone specifying information in the communication controlling circuit 11) to the created piece of class-2 zone specifying information (step S411).

Next, the CPU 12 notifies the user of the completion of the process (step S412). More specifically, the CPU 12 performs a process of transmitting information in a form compliant with the communication protocol with the operating terminal 40 (HTML data or text data) to the operating terminal 40.

The CPU 12 then finishes this third zoning class converting process.

The user who has been notified of the completion of the third zoning class converting process confirms that the new device can access the devices in the same zone, to make sure. The user then finishes the device changing operation.

[In Removing Device]

A removed device checking process is a process that is utilized in removing (detaching) a device from the switching device 10.

To remove a device utilizing the removed device checking process, the user conducts, on the operating terminal 40, a start instructing operation of the removed device checking process including an operation of specifying a port from which the device is removed (detached).

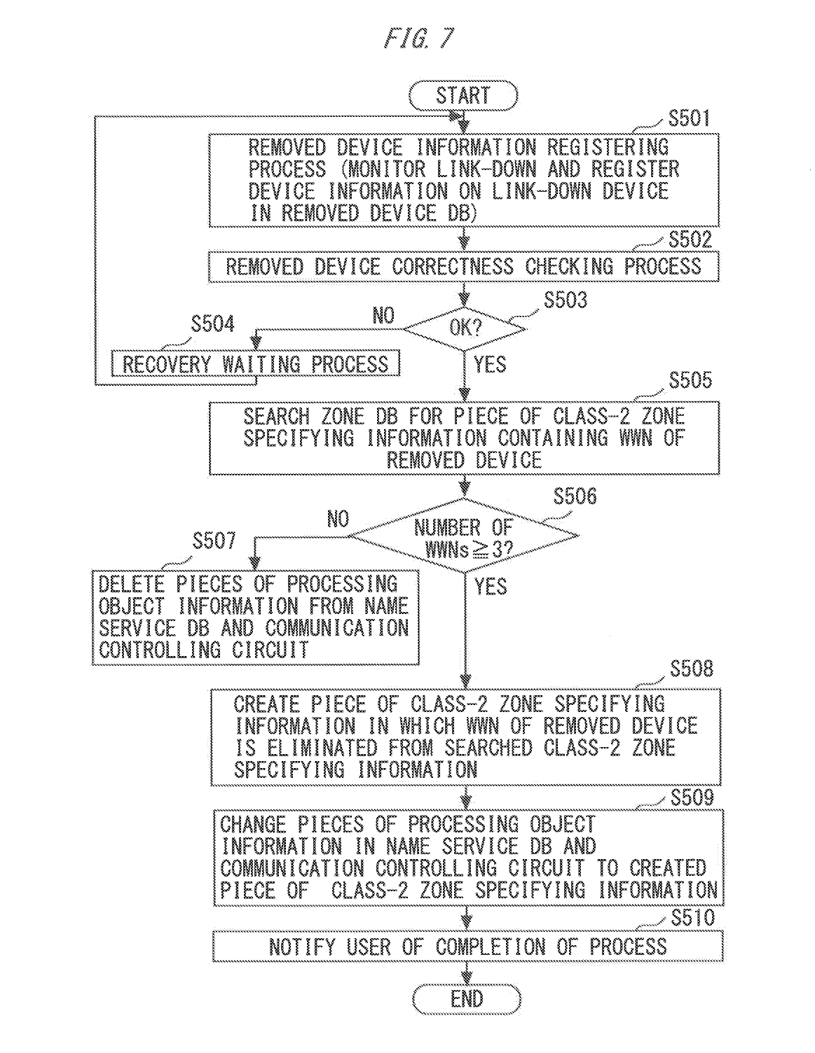

When the start instructing operation above is conducted, the CPU 12 performs the removed device checking process the procedure of which is illustrated in FIG. 7.

The processes of steps S501 to S504 in this removed device checking process have the same details as those of processes of steps S401 to S404 in the changed device checking process (FIG. 5), respectively.

As illustrated in FIG. 7, when obtaining a response from the user indicating that the removed device is correct one (step S503; YES), the CPU 12 searches the zone DB 31 for apiece of class-2 zone specifying information containing the WWN of the removed device (step S505).

Subsequently, the CPU 12 determines whether the number of WWNs in the searched class-2 zone specifying information is three or more (step S506). Then, if the number of WWNs is less than three (step S506; NO), the CPU 12 deletes the pieces of processing object information in the name service DB 32 and the communication controlling circuit 11 (the piece of class-2 zone specifying information in the name service DB 32 that is read this time, and the same piece of class-2 zone specifying information in the communication controlling circuit 11) (step S507).

In short, if the number of WWNs in the piece of class-2 zone specifying information containing the WWN of the removed device is less than (equal to two) and the removed device is removed, there is just one device left. Then, subjecting just one device to zoning is meaningless, and thus the CPU 12 deletes the pieces of processing object information in the name service DB 32 and the communication controlling circuit 11 (step S507).

The CPU 12 that has finished the process of step S507 notifies the user of the completion of the process (step S508), and finishes this removed device checking process.

In contrast, if the number of WWNs in the searched class-2 zone specifying information is three or more (step S506; YES), the CPU 12 creates a piece of class-2 zone specifying information in which the WWN of the removed device is eliminated from the searched class-2 zone specifying information (step S508). Next, the CPU 12 changes the pieces of processing object information in the name service DB 32 and the communication controlling circuit 11 (the piece of class-2 zone specifying information in the name service DB 32 that is read this time, and the same piece of class-2 zone specifying information in the communication controlling circuit 11) to the created piece of class-2 zone specifying information (step S509).

The CPU 12 then notifies the user of the completion of the process (step S508), and finishes this removed device checking process.

### Effects of Embodiment

As described above, the switching device 10 has the function of converting a piece of class-1 zone specifying information to specify a zone using the combination of port numbers into a piece of class-2 zone specifying information to specify the zone using the combination of WWNs, based on the piece of information in the name service DB 32. Accordingly, the switching device 10 is a device that allows the WWN zoning with a high security to be performed without performing a complicated operation such as checking the WWNs of the devices.

In addition, the switching device 10 also has the function of converting a piece of class-2 zone specifying information into apiece of class-1 zone specifying information based on a piece of information based on the name service DB 32 (converting WWN zoning into port zoning). Accordingly, just using the switching device 10 allows an operation to be readily performed (in such a manner as to dispense with a complicated setting operation) the operation in which the WWN zoning is once converted into the port zoning and a device is replaced and the connection of the replaced device is checked, following which the port zoning is returned to the WWN zoning.

In addition, the switching device 10 also has the function of presenting device information on a removed device/new device to a user. Accordingly, just using the switching device 10 can also prevent a device from being removed/replaced in error.

According to the disclosed technique, there can be provided a switching device that allows the zoning class to be readily changed, a non-transitory computer readable medium recorded with a control program that can implement such a switching device, and a zoning setting method that allows the WWN zoning to be readily set.

### Modification

The switching device 10 according to the above-described embodiment can be subjected to various modifications. For example, the switching device 10 can be modified into a device in which the combination of the IP (internet protocol) address or MAC (media access control) address of a device can be used as a piece of class-2 zone specifying information.

In addition, the switching device 10 can be modified into a device having a hardware configuration different from the above-described one (e.g., a device including the communication controlling circuit 11 that does not have the memory 11a). Furthermore, the switching device 10 can be modified into a device having a software configuration different from the above-described one (e.g., a device having configurations (data structures) of the DBs 31 to 33 different from those of the above-described configurations, or a device in which an order of reading various kinds of information is different from that of the above-described order).

What is claimed is:

1. A switching device, comprising:
a plurality of ports;
a connection management database that associates pieces of identification information on devices connected to the plurality of respective ports with pieces of identification information on the ports and manages the pieces of identification information;
a zone specifying information storing unit in which a plurality of pieces of zone specifying information are stored, each of which is either a piece of class-1 zone specifying information to specify a plurality of devices to be subjected to zoning using pieces of identification information on the ports to which the plurality of devices are connected, or a piece of class-2 zone specifying information to specify a plurality of devices to be subjected to zoning using pieces of identification information on the plurality of devices;
a zoning controlling unit that treats the plurality of devices connected to the plurality of ports as a plurality of zones based on the plurality of pieces of zone specifying information stored in the zone specifying information storing unit, and restricts access between the zones; and
a zoning class changing unit that can perform a first zoning class converting process and a second zoning class converting process, the first zoning class converting process obtaining, from the connection management database, pieces of identification information on devices connected to ports whose pieces of identification information are contained in a given piece of class-1 zone specifying information and changing the piece of class-1 zone specifying information in the zone specifying information storing unit to a piece of class-2 zone specifying information containing the obtained pieces of identification information on the devices, and the second zoning class converting process obtaining, from the connection management database, pieces of identification information on ports to which devices are connected whose pieces of identification information are contained in a given piece of class-2 zone specifying information and changing the class-2 zone specifying information in the zone specifying information storing unit to a piece of class-1 zone specifying information containing the obtained pieces of identification information on the ports.

2. The switching device according to claim 1, wherein the zoning class changing unit has a function of outputting a piece of device information on a device that is detached from a specified port.

3. The switching device according to claim 1, wherein the zoning class changing unit has a function of outputting a piece of device information on a device that is detached from a specified port and a piece of device information on a device that is connected instead of the detached device.

4. A non-transitory computer readable medium recorded with a control program that causes a processor in a switching device to execute processing comprising:
the switching device comprises a plurality of ports; a connection management database that associates pieces of identification information on devices connected to the plurality of respective ports with pieces of identification information on the ports and manages the pieces of identification information; a zone specifying information storing unit in which a plurality of pieces of zone specifying information are stored, each of which is either a piece of class-1 zone specifying information to specify a plurality of devices to be subjected to zoning using pieces of identification information on the ports to which the plurality of devices are connected, or a piece of class-2 zone specifying information to specify a plurality of devices to be subjected to zoning using pieces of identification information on the plurality of devices; a zoning controlling unit that treats the plurality of devices connected to the plurality of ports as a plurality of zones based on the plurality of pieces of zone specifying information stored in the zone specifying information storing unit, and restricts access between the zones; and the processor;
performing a first zoning class converting process and a second zoning class converting process, the first zoning class converting process obtaining, from the connection management database, pieces of identification information on devices connected to ports whose pieces of identification information are contained in a given piece of class-1 zone specifying information and changing the piece of class-1 zone specifying information in the zone specifying information storing unit to a piece of class-2 zone specifying information containing the obtained pieces of identification information on the devices, and the second zoning class converting process obtaining, from the connection management database, pieces of identification information on ports to which devices are connected whose pieces of identification information are contained in a given piece of class-2 zone specifying information and changing the class-2 zone specifying information in the zone specifying information storing unit to a piece of class-1 zone specifying information containing the obtained pieces of identification information on the ports.

5. A zoning setting method by which a processor in a switching device executes processing comprising:
the switching device comprises a plurality of ports; a connection management database that associates pieces of identification information on devices connected to the plurality of respective ports with pieces of identification information on the ports and manages the pieces of identification information; a zone specifying information storing unit in which a plurality of pieces of zone specifying information are stored, each of which is either a piece of class-1 zone specifying information to specify a plurality of devices to be subjected to zoning using pieces of identification information on the ports to which the plurality of devices are connected, or a piece of class-2 zone specifying information to specify a plurality of devices to be subjected to zoning using pieces of identification information on the plurality of devices; a zoning controlling unit that treats the plurality of devices connected to the plurality of ports as a plurality of zones based on the plurality of pieces of zone specifying information stored in the zone specifying information storing unit, and restricts access between the zones; and the processor;
obtaining, for each piece of class-1 zone specifying information in the zone specifying information storing unit, from the connection management database, pieces of identification information on devices connected to ports whose pieces of identification information are contained in the piece of class-1 zone specifying information to create a piece of class-2 zone specifying information containing the obtained pieces of identification information on the devices, and changing each piece of class-1 zone specifying information in the zone specifying information storing unit to the created piece of class-2 zone specifying information.
